(19) United States
(12) Patent Application Publication
(10) Pub. No.: US 2026/0292433 A1
(43) Pub. Date: Sep. 24, 2026

(54) METHOD AND DEVICE FOR CAPTURING AN ACOUSTIC REPRESENTATION OF AN ENVIRONMENT

(71) Applicant: LEWITT GMBH, Wien (AT)

(72) Inventors: Kaspar GLATTFELDER, Wien (AT); Manuel BRANDNER, Wien (AT); Christian WALTER, Wien (AT); Thibaud NECCIARI, Wien (AT)

(21) Appl. No.: 19/490,864

(22) PCT Filed: Jun. 7, 2024
(86) PCT No.: PCT/AT2024/060222

§ 371 Date: Dec. 5, 2025

(30) Foreign Application Priority Data
Jun. 7, 2023 (AT) A 50450/2023

(51) Int. Cl. H04S 7/00; H04R 5/027

(52) U.S. Cl. CPC H04S 7/303; H04R 5/027; H04S 2420/01

(57) ABSTRACT

Method of capturing an acoustic representation of an environment comprising: i) placing a device into the environment, the device being oriented in a first orientation and comprising at least three acoustic sensors; ii) emitting an acoustic signal with an emitting unit; iii) measuring the acoustic signal and possible reflections with the acoustic sensors; and iv) obtaining the acoustic representation of the environment based on the measured acoustic signal and the measured possible reflections, the acoustic representation including an acoustic reaction of the environment and a directional information corresponding to the acoustic reaction, wherein the device is a wearable acoustic device. The invention further relates to a device for usage in such a method, a method of generating binaural sound signals and a system for capturing an acoustic representation.

### CROSS REFERENCE TO RELATED APPLICATIONS

The present application is a U.S. National Phase of International Application No. PCT/AT2024/060222 entitled “METHOD AND DEVICE FOR CAPTURING AN ACOUSTIC REPRESENTATION OF AN ENVIRONMENT”, and filed on Jun. 7, 2024. International Application No. PCT/AT2024/060222 claims priority to Austrian Patent Application No. A 50450/2023 filed on Jun. 7, 2023. The entire contents of each of the above-listed applications are hereby incorporated by reference for all purposes.

### TECHNICAL FIELD

The present invention relates to a method of capturing an acoustic representation of an environment, in particular of a room with a specific audio playback situation, comprising the following steps:
i) placing a device into the environment, the device being oriented in a first orientation and comprising at least three acoustic sensors configured to measure acoustic signals in the environment;
ii) emitting at least one acoustic signal into the environment by means of at least one emitting unit, preferably a loudspeaker;
iii) measuring the at least one acoustic signal and possible reflections in the environment by means of the at least three acoustic sensors; and
iv) obtaining the acoustic representation of the environment based on the at least one measured acoustic signal and the measured possible reflections, the acoustic representation including an acoustic reaction of the environment, preferably an impulse response, in response to the at least one acoustic signal emitted by the emitting unit and a directional information corresponding to the acoustic reaction.

### BACKGROUND AND SUMMARY

Further, the invention relates to a device for usage for capturing an acoustic representation of an environment, the device comprising at least three acoustic sensors configured to measure acoustic signals in the environment, the acoustic representation including an acoustic reaction of the environment, preferably an impulse response, in response to at least one acoustic signal and a directional information corresponding to the acoustic reaction.

The invention also relates to a method of generating a binaural sound signal and a system for capturing an acoustic representation of an environment.

The way sound is perceived in an environment by a listener very much depends on the presence of objects such as walls, ceilings, floors, and pillars. Depending on the respective material properties, said objects may reflect and attenuate sound waves during their propagation and thus influence the sound field of an environment. Therefore, the stone interiors of gothic cathedrals cause music or voice to sound vastly different compared to well-insulated movie theaters or living rooms with sound-absorbing curtains, couches, and carpets.

In many applications it is desired to emulate the playback of music in a specific environment. For instance, listeners may want to enjoy their music with headphones at home and perceive it as if it were being played in a theatre or stadium, thereby having the impression of a live concert. Conversely, music producers may need to understand how their music will be perceived in different environments, such as a concert hall or theatre where it will be played.

One method to capture a realistic perception of sound in an environment is to record sound with a dummy comprising a dummy head that has microphones attached in its ears. Sound waves that propagate in the environment will be reflected and damped by objects in the environment and by the body parts of the dummy, thereby generating a specific perception of sound at the left and the right ear of the dummy. The microphones in the dummy head will record the sound which then, when played with headphones, give a realistic impression to the listener. These recordings of sound may be also referred to as binaural recordings. One disadvantage of this method is that the recorded sound signals do not comprise any directional information. Thus, it is neither possible to simulate reproduction of the music at a different position or a different orientation in the environment nor to change the perception of the sound signal if a listener moves his head. Further, dummies for binaural recordings are highly expensive and the setup for binaural recordings is very complex.

To provide a plurality of orientations and positions in an environment, one could simply perform multiple binaural recordings in the environment at different positions and orientations. However, this approach is very time-consuming and produces a large amount of data. Another method is to record a set of so-called binaural room impulse responses (BRIRs), which include information of sound impressions of a room as perceived by a listener. A BRIR is the impulse response of a room as perceived by a listener with his or her left or right ear. To obtain BRIRs, room impulse responses may be measured with the above-mentioned dummy at different positions and orientations. A realistic impression of sound in the room where the BRIR was captured may then be generated by convolving a desired sound signal, such as a music or voice signal, recorded in an anechoic room, with the BRIR at a specific position and orientation. U.S. Pat. No. 10,390,171 B2 discloses a method which uses BRIRs to provide sound impressions of specific environments to a listener. The BRIRs are stored in a database. A sensor in the headphones of a listener is configured to measure the head orientation of the listener. A sound signal may then be generated with the BRIR corresponding to the current head orientation of the listener.

As already mentioned above, one disadvantage of the described methods is that dummies used for measuring BRIRs are very expensive. Another disadvantage is that BRIRs include anatomic properties of an average person. However, each person has different anatomic properties, such the circumference of the head and the distance between the ears, so that music or voice generated by means of BRIRs may sound different to different listeners. Further, due to the anatomic differences of people, each person may experience a slightly different location of the sound source when hearing sound generated with a non-suitable BRIR.

In the prior art, there are also well-established but complex methods and devices for obtaining directional information without anatomic properties of persons. Among them, ambisonic microphones and the associated ambisonics formats are a popular example. For example, an ambisonic microphone array is used in ZAUNSCHIRM MARKUS ET AL: “BRIR Synthesis Using first-Order Microphone Arrays”, AES CONVENTION 144; May 2018, AES, 60 EAST 42ND STREET, ROOM 2520 NEW YORK 10165-2520, USA, 14 May 2018 (2018 May 14). These devices can capture the sound field of an environment, including directional information of the captured sound signal. Commercially available first order ambisonic microphones consist of four microphones precisely arranged in a tetrahedral configuration. The captured sound signals are then converted into the so-called B-format, which is a speaker-independent representation of the sound field. B-format signals can be decoded to a specific speaker setup, providing an immersive audio experience. These available ambisonic microphones and the associated format are essential tools for sound engineers and researchers in various fields, including virtual reality, film production, and music production.

However, similar to the above-mentioned dummies for measuring BRIRs and binaural recordings, capturing the acoustic representation of an environment using ambisonic microphones or similar devices is a costly and complex procedure that requires specialized expertise in acoustics. As a result, it is typically performed by professionals only.

In the prior art, also headphones with microphones for active noise cancelling are known. Such headphones are, for example, disclosed in WO 2016/090342 A2.

US 2008/0004872 A1 discloses headphones with directional microphones for focusing on a sound source, for example on a person.

Accordingly, it is an objective of the present invention to eliminate or at least alleviate at least some of the disadvantages of the prior art. Preferably, it is an objective of the present invention to provide a method and a device which allow for a simplified way of capturing an acoustic representation of an environment that may also be applied by unexperienced end-consumers. Another preferred objective is that the captured acoustic representation of the environment shall be independent from anatomic influences of a consumer.

The objective is solved by a method of capturing an acoustic representation of an environment, a method of generating a binaural sound signal, a system for capturing an acoustic representation of an environment, and a device as described herein.

According to the invention, the above-described method of capturing an acoustic representation of an environment is characterized in that the device is a wearable acoustic device for acoustic reproduction, preferably headphones. Advantageously, the same device that allows a user to listen to music or voice also allows for capturing an acoustic representation of an environment. By providing a wearable acoustic device with the functionality of capturing an acoustic representation, users can easily record and share acoustic representations of certain environments. The acoustic representation captured by the wearable acoustic device does not comprise any physiological or anatomic influences of a person and thus differs from, e.g., BRIRs (Binaural Room Impulse Response) in this aspect. Anatomic properties of a person, such as a head-related transfer function (HRTF) or a head-related impulse response (HRIR) may be combined with the acoustic representation in an additional step when a binaural sound signal shall be generated based on the captured acoustic representation of an environment. In other words, the acoustic representations captured by the inventive wearable acoustic device are devoid of human representations, such as HRIRs or HRTFs. Since the acoustic sensors are included into the wearable acoustic device, no additional equipment such as binaural microphones or ambisonic microphones is required. The environment may be any place in which acoustic sound waves can propagate, for example a stadium, a concert area or even a cave or a forest. Preferably, the environment is a room, in particular a room within a building. The acoustic device comprises at least three acoustic sensors, which may be microphones. Of course, more than three acoustic sensors, for example four, five, six or even more acoustic sensors, may be used. The acoustic sensors may all be of the same type. In one embodiment of the invention, the acoustic sensors may all be electret microphones or MEMS-microphones (MEMS-Micro Electro-Mechanical System) The microphones may have an analog or digital output. The acoustic sensors may all be omnidirectional microphones. In another embodiment of the invention, the at least three acoustic sensors comprise at least two different types of acoustic sensors. At least one acoustic sensor of the at least three sensors may be used to capture an acoustic reaction of the room, preferably a room impulse response. At least two, preferably all of the at least three sensors may be used to measure directional information of incoming sound waves. Directional information of sound waves may be measured by detecting phase differences and/or time differences of the incoming sound waves arriving at the acoustic sensors and performing geometrical calculations. In the meaning of the invention, a wearable acoustic device is a device that can reproduce music. The wearable acoustic device is preferably a pair of headphones or earbuds. However, the wearable acoustic device may also be a virtual reality device. In step i), the wearable acoustic device is placed into the environment from which an acoustic representation shall be captured. After placing the wearable acoustic device, people and objects that are not part of the environment are removed from the environment. In step ii), at least one acoustic signal is emitted into the environment by means of at least one emitting unit, preferably a loudspeaker. The at least one acoustic signal is preferably any acoustic signal that allows to directly or indirectly derive an impulse response. In one exemplary embodiment of the invention, the at least one acoustic signal is an impulse, preferably an approximation of a Dirac Impulse, or a chirp signal. In step iii), the at least one acoustic signal and possible reflections in the environment are measured by means of the at least three acoustic sensors. Reflections may stem from deflections of the at least one acoustic signal at objects, such as walls, floors, furniture, pillars or ceilings. The wearable acoustic device is placed and kept in a first orientation during steps ii) and iii). In step iv), the acoustic representation of the environment is obtained based on the at least one measured acoustic signal and the measured possible reflections. The acoustic representation includes an acoustic reaction of the environment, which may be a room impulse response or a transfer function. A room impulse response is the acoustic reaction of the environment to an impulse that approximates a Dirac impulse. Thus, a room impulse response may be simply obtained by measuring the reaction of the environment to an impulse. To obtain a transfer function, the Laplace transform of the measured at least one acoustic signal and possible reflections in the environment may be set into relation with the Laplace transform of the at least one (original) acoustic signal. Since the transfer function is the Fourier transform of the impulse response, these two representations can be considered as equivalent representations and can be transformed from one to another without loss of information. The acoustic representation further includes a directional information corresponding to the acoustic reaction. The directional information may comprise directions of arrival of incoming sound waves that may be associated with individual parts of the acoustic reaction. For example, with each sampling period of the acoustic reaction, a direction of arrival, for instance in the form of spherical angels, may be associated. In a preferred embodiment, the steps i)-iv) are carried out in the sequence of their numbering.

In a preferred embodiment of the invention, the acoustic representation of the environment is a directional room impulse response composed of a room impulse response and corresponding directional information. Preferably, the impulse response comprises consecutive sampling periods and each sampling period is associated with a directional information, in particular a direction of arrival of incoming sound waves. Directional information may be a room direction from where the incoming sound waves of the room impulse response have arrived at the wearable device during an associated sampling period. The directional information may be, for instance, stored in the form of angles, such as spherical angles, or cartesian coordinates relative to the wearable acoustic device.

Preferably, the acoustic representation is devoid of any acoustic influence of a wearer wearing the wearable acoustic device. This may be achieved by placing the wearable acoustic device on an object during the capturing of the acoustic representation. Alternatively, the acoustic influence of a wearer may be also subtracted mathematically from the acoustic representation.

In step i), the wearable acoustic device may be placed on an object, preferably a stand for the wearable acoustic device, in particular a stand with a defined axis of rotation. The wearable acoustic device may remain on the object at least during steps ii) and iii). In a preferred embodiment, the object may be a stand. The stand may have a holding element for securing the wearable acoustic device.

Preferably, the at least one acoustic signal may be any signal that allows to directly or indirectly derive a room impulse response. However, it is particularly favorable if the at least one acoustic signal comprises a stimulus signal, such as a chirp signal or an impulse, and preferably a trigger signal. The impulse may approximate a Dirac Impulse. The chirp signal may be a logarithmic chirp signal. Alternatively, the at least one acoustic signal may also comprise a pseudorandom binary sequence, such as a Maximum Length Sequence (MLS), as stimulus signal. The trigger signal allows to unambiguously identify the start of the at least one acoustic signal or the stimulus signal, respectively. The trigger signal may be, for example, a sinusoid of any length, but preferably of at least one full time period of the corresponding frequency of the sinusoidal trigger signal.

In one embodiment of the invention, the at least three acoustic sensors form a line array, in particular a curved line array. If the at least three acoustic sensors comprise acoustic sensors with a directivity, the main axis of directivity of these sensors may be oriented in the same direction. If the wearable acoustic device comprises a headband, as this is the case with headphones, the at least three acoustic sensors are preferably located in or on a headband of the wearable acoustic device, since this is the acoustic most transparent area of such a wearable acoustic device.

In another embodiment of the invention, one of the at least three acoustic sensors, which is preferably an essentially omnidirectional acoustic sensor, is used for obtaining a room impulse response and at least two of the at least three acoustic sensors, preferably all of the at least three acoustic sensors, are used for obtaining directional information corresponding to the room impulse response. Preferably, all acoustic sensors are omnidirectional microphones. However, in one embodiment of the invention, the acoustic sensor for obtaining the room impulse response may be an omnidirectional microphone, while the other acoustic sensors may be directional microphones. The acoustic sensor for obtaining the room impulse response may form the center of the arrangement of the at least three acoustic sensors. As acoustic sensors, electret microphones or MEMS-microphones may be used.

In order to allow for capturing a complete acoustic representation of the environment, a first acoustic signal and then a second acoustic signal may be emitted into the environment, wherein, during the first acoustic signal, the wearable acoustic device may be arranged in the first orientation, and during the second acoustic signal, the wearable acoustic device may be arranged in a second orientation which is different from the first orientation. The wearable acoustic device measures the first acoustic signal and possible reflections in the first orientation by means of the at least three acoustic sensors. Similarly, the wearable acoustic device measures the second acoustic signal and possible reflections in the second orientation by means of the at least three acoustic sensors. Based on the measurements in the first and second orientation, the acoustic representation of the environment may be obtained. The second orientation may be essentially 90° to the first orientation. Preferably, the absolute position of the wearable acoustic in the environment device may be essentially the same for the first and the second orientation. To bring the wearable acoustic device from the first orientation into the second orientation, the wearable acoustic device may be rotated by 90° around a vertical axis. This may be carried out by a person or automatically with a stand for the wearable acoustic device that has an electric motor. With respect to steps i)-iii), these may be repeated with the wearable acoustic device in the second orientation.

The invention also relates to a method of generating a binaural sound signal, the binaural sound signal emulating reproduction in an environment. The method of generating a binaural sound signal comprises the following steps:
Capturing an acoustic representation of the environment by applying a method of capturing an acoustic representation of an environment as described above;
Generating the binaural sound signal by combining the captured acoustic representation of the environment with an acoustic representation of a human, in particular an acoustic representation of a human head, for example at least one a head-related transfer function or at least one a head-related impulse response, and with sound data, preferably music or voice.

The combination of the acoustic representation, the acoustic representation of a human and the sound data may be carried out by mathematic operations, such as convolution or multiplication. As representation of a human head, head-related transfer functions (HRTF) or head-related impulse responses (HRIR) may be used. HRTFs and HRIRs may be stored in and retrieved from a library or data base. HRTFs or HRIRs may be generated with computer simulations and/or with the aid of dummies comprising dummy heads having microphones in their ears. To obtain HRTFs or HRIRs, a dummy may be placed in an anechoic room and an acoustic signal, preferably an impulse, may be emitted into the room. The emitted signal may be measured with the microphones of the dummy so as to obtain a HRIR. The HRIR may be transformed into a HRTF. Alternatively, simulated HRTFS or HRIRs may be used. The sound data may be music or voice, preferably recorded in an anechoic room to avoid influences of the room where the sound data was generated. HRTFs and HRIRs may be equalized to reduce the influence of the microphones in the head of the dummy.

After generating the binaural sound signal, it may be reproduced in a wearable acoustic device, in particular headphones. The wearable acoustic device may be the same wearable acoustic device that has been used to capture the acoustic representation of the environment or a different wearable acoustic device. Preferably, both wearable acoustic devices are of the same type.

In a preferred embodiment, the wearable acoustic device comprises a tracking sensor which tracks a movement of the wearable acoustic device, wherein the binaural sound signal is adapted to the tracked movement based on the directional information included in the acoustic representation. In this way, a listener wearing the wearable acoustic device perceives the binaural sound signal as if he/she were in the environment where the acoustic representation has been captured. Upon moving the wearable acoustic device, the binaural sound signal is adapted to maintain the perception to the listener that the sound originates from a specific (virtual) position in the (virtual) environment. As in the real environment from which the acoustic representation has been captured, the sound perception alters when the listener moves his head into another orientation due to reflections at objects in the environment. Thus, the generated sound signal may be changed accordingly. In other words, a virtual sound source may be simulated and the binaural sound signal may be adapted as it would be the case in the real environment from where the acoustic representation has been captured. The tracking sensor may be an inertial measurement unit (IMU). The tracking sensor may be a MEMS- or NEMS-sensor.

As already mentioned above, the acoustic representation of a human may be selected from a data base comprising multiple representations of a human. To avoid costly measurement procedures to capture representations for each individual listeners, listeners may, in a first step, coarsely preselect representations of a human based on his or her body dimensions, such as the distance between the ears, head circumference, shoulder circumference, and/or height. By means of an optional selection routine for representations of a human, the most suitable representation of a human from multiple preselected representations may be found for a listener in a second step. During the selection routine, the listener may hear binaural sound signals reproduced by the wearable acoustic device and determine their virtual source of origin and/or their virtual trajectory by looking into the direction from where the sound seems to origin while wearing the wearable acoustic device. If the difference between the source of origin/the virtual trajectory determined by the listener and the actual virtual location/actual virtual trajectory is below a location threshold, the selected representation of a human may be considered suitable. The smaller the difference, the more suitable a representation of a human is.

The invention also relates to a device for usage for capturing an acoustic representation of an environment, the device comprising at least three acoustic sensors configured to measure acoustic signals in the environment, the acoustic representation including an acoustic reaction of the environment, preferably an impulse response, in response to at least one acoustic signal and a directional information corresponding to the acoustic reaction, wherein the device is a wearable acoustic device for acoustic reproduction, preferably headphones.

The inventive device may be used in the above-described method of capturing an acoustic representation of an environment. Thus, the features and advantages described above may be transferred to the inventive device. The inventive device may also be used to reproduce binaural sound signals that are being adapted to a tracked movement of the device based on the directional information included in an acoustic representation. The adaption of the binaural sound signals to the tracked movement may be carried out in a separate computational device, such as a smartphone, a local computer or a remote server, separate from the wearable acoustic device, the computational device comprising a computational unit for calculations. The wearable acoustic device may be connected to the computational device wirelessly or via a cable. Alternatively, the adaption of the binaural sound signals to the tracked movement may be carried out in the wearable acoustic device. In other words, said computational unit may be included in the wearable acoustic device and may adapt the binaural sound signals to the tracked movement of the head of a wearer.

Preferably the device further comprises a tracking sensor, in particular an inertial measurement unit.

The invention also relates to a system for capturing an acoustic representation of an environment, in particular a room, the system comprising:
a device for usage for capturing an acoustic representation of an environment as described above;
an emitting unit, preferably a loudspeaker, for emitting at least one acoustic signal into the environment; and
a processing unit configured obtain the acoustic representation of the environment based on at least one acoustic signal and possible reflections measured by the at least three acoustic sensors of the device, the acoustic representation including an acoustic reaction of the environment, preferably an impulse response, in response to at least one acoustic signal emitted by the emitting unit and a directional information corresponding to the acoustic reaction.

The inventive system may carry out the method of capturing an acoustic representation of an environment as described above. Thus, the features and advantages described above may be transferred to the inventive device. The device for usage for capturing an acoustic representation of an environment may transfer the measured at least one acoustic signal and possible reflections in the environment to the processing unit via a wire or wirelessly. The processing unit may be included, for example, in the same or a similar computational device as described above, which is separate from the wearable acoustic device and may be a smartphone, a local computer or a remote server. However, in an alternative embodiment, the processing unit may be included into the wearable acoustic device.

In the following, exemplary embodiments of the invention are described with reference to the drawings, which the invention shall not be restricted to, however.

### BRIEF DESCRIPTION OF THE FIGURES

The drawings show:

FIG. 1 an environment whose acoustic representation shall be captured;

FIG. 2 a wearable acoustic device;

FIG. 3 a wearable acoustic device on a stand;

FIG. 4A a wearable acoustic device in a first orientation;

FIG. 4B a wearable acoustic device in a second orientation;

FIG. 5A schematically a room impulse response;

FIG. 5B schematically an acoustic representation;

FIG. 5C an impulse response with associated directions of arrival;

FIG. 6 a setup of a system for capturing an acoustic representation of an environment;

FIG. 7 the generation of a binaural sound signal;

FIG. 8 a human head;

FIG. 9 an exemplary implementation for selection of an acoustic representation of a human; and

FIG. 10 a simulation of a sound source.

### DETAILED DESCRIPTION

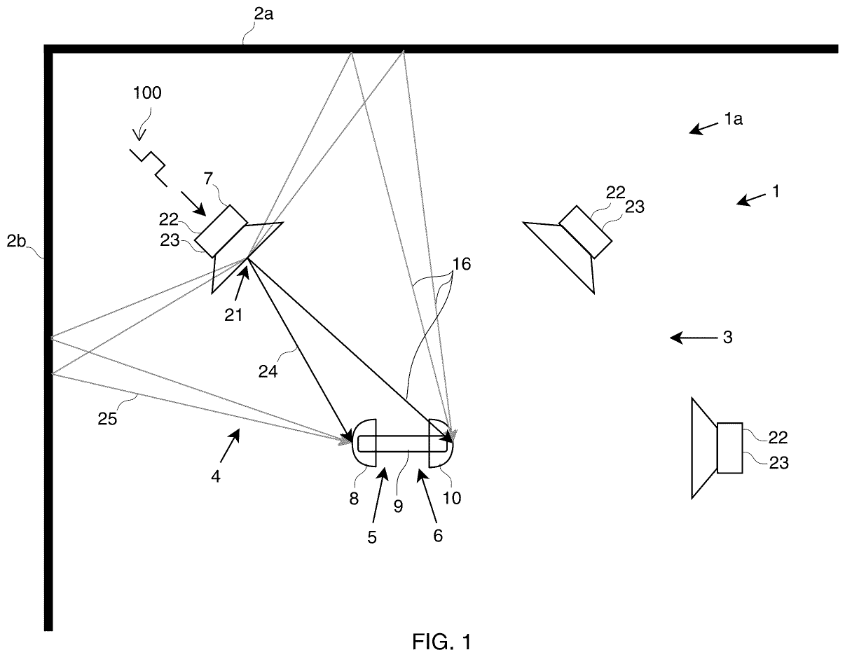

FIG. 1 shows an environment 1 comprising walls 2a, 2b and a floor 3 in a top view. In the shown embodiment, the environment 1 is a room 1a within a building (not shown). For illustration purposes, only the two walls 2a, 2b and the floor 3 are depicted in FIG. 1. However, in general, the room 1a may, of course, comprise more than two walls 2a, 2b and also a ceiling.

Due to the specific arrangement of the walls 2a, 2b and the floor 3 and their respective material properties, the environment 1 has individual acoustic properties which lead to a specific perception of sound 4 for a listener at a specific location 5 within the environment 1. It is notable that the perception of sound 4 can vary depending on the specific location 5 and orientation 6 of a listener within the environment 1. This means that even slight changes in location 5 or orientation 6 can lead to different perceptions of the same sound 4. Of course, the location of the sound source 7 also contributes to the specific perception of sound 4 to a listener.

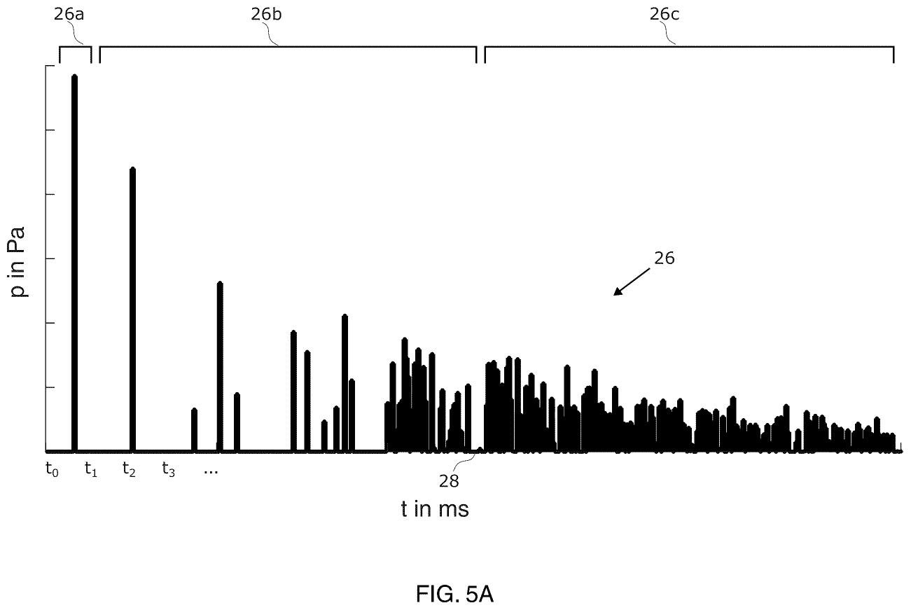

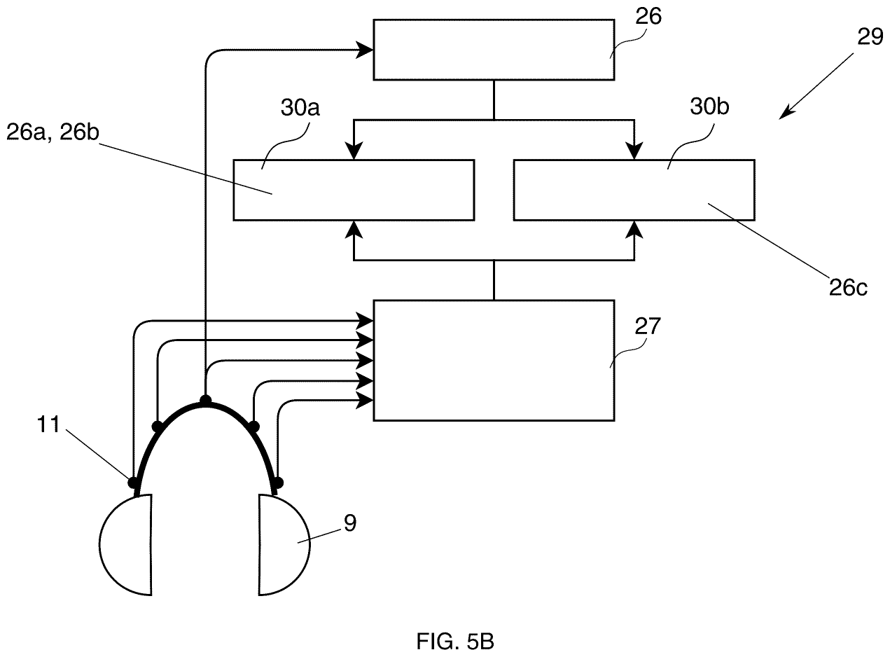

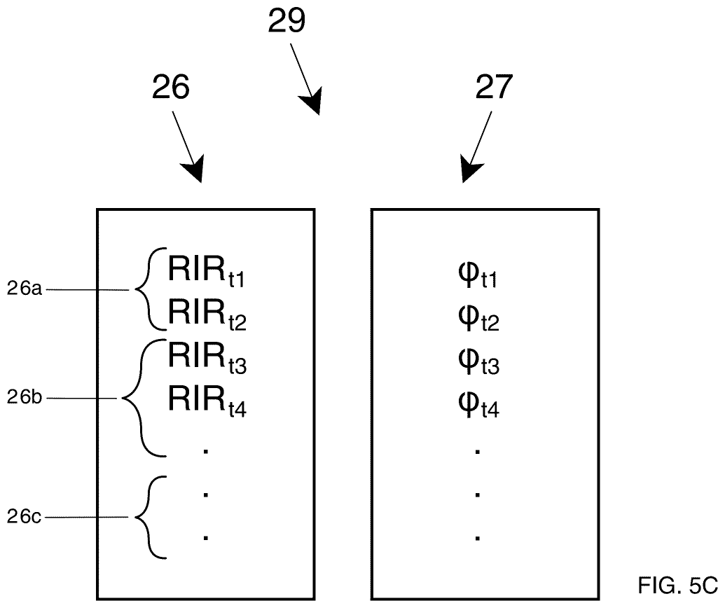

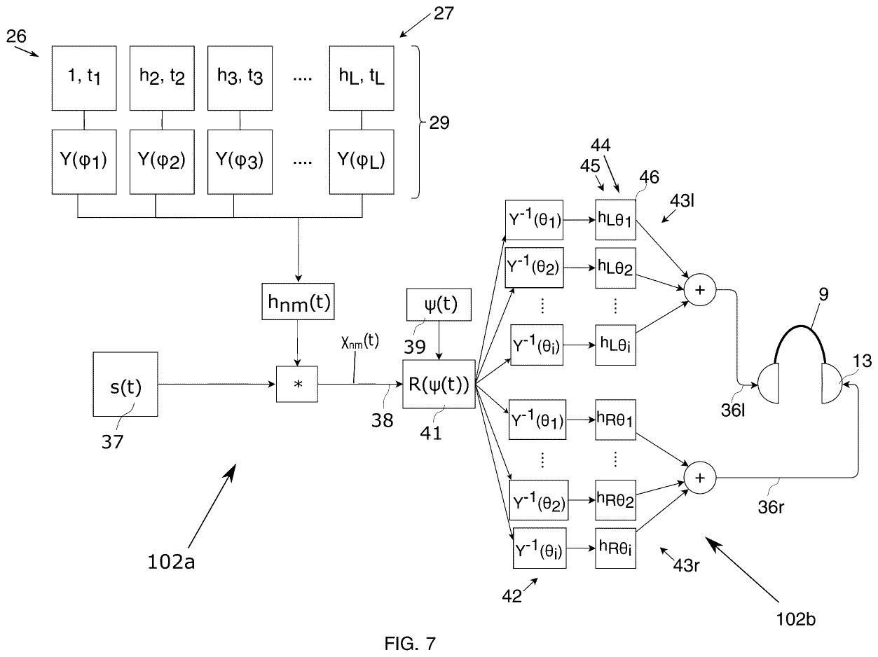

In order to capture an acoustic representation 29 (see FIG. 5B or FIG. 7) of the environment 1 at a specific location 5, a device 8 is placed into the environment 1 at the location 5. According to the invention, the device 8 is a wearable acoustic device 9, here in the form of headphones 10. The wearable acoustic device 9 is configured to reproduce sound to a listener, for example music or voice. The wearable acoustic device may be worn on the listener's head.

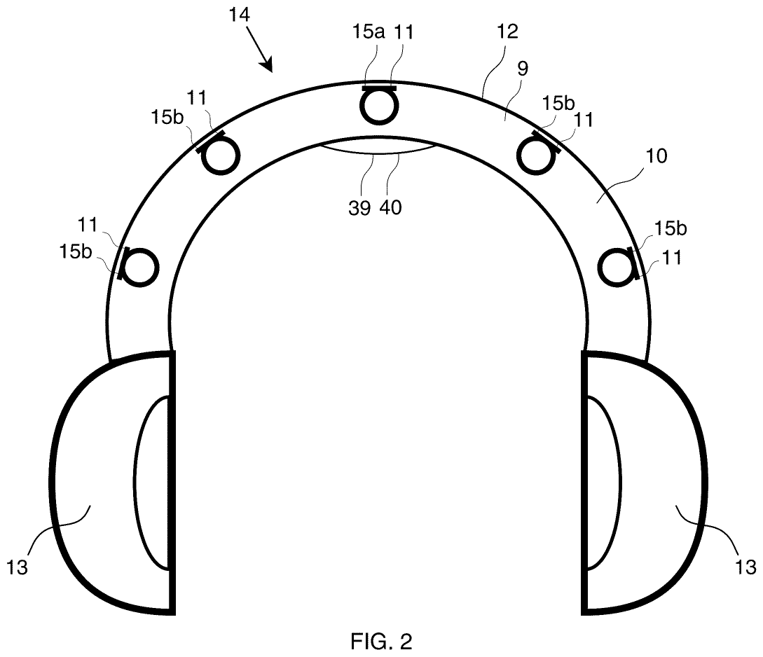

FIG. 2 shows the wearable acoustic device 9 in an enlarged view. The wearable acoustic device 9 has five acoustic sensors 11 disposed on the headband 12, which connects the earpieces 13 of the wearable acoustic device 9. The acoustic sensors 11 are arranged essentially equidistantly on the headband 12, thereby forming a curved line array 14. In the embodiment shown, the acoustic sensor 11 in the center of the line array 14 is an omnidirectional acoustic sensor or microphone 15a and may be used to capture an acoustic reaction, preferably a room impulse response 26 (see FIG. 5A). The other acoustic sensors 11 left and right to the omnidirectional microphone 15a are also omnidirectional microphones 15b, but may be directional microphones as well. All acoustic sensors 11 may be used to capture directional information 27 (see FIG. 5B) of incoming sound waves 16 (see FIG. 1), as will be explained below. For reasons of acoustic transparency, the acoustic sensors 11 are preferably positioned on the upper side of the headband 12. This placement of the acoustic sensors 11 allows the acoustic sensors 11 to be exposed to incoming sound waves 16 without obstruction, ensuring accurate capture of the incoming sound waves 16. The omnidirectional microphone 15a is preferably located centrally on the headband 12, since this is the acoustically most transparent position on the wearable acoustic device 9. The wearable acoustic device 9 also comprises a tracking sensor 39, preferably an inertial measurement unit 40, as will be explained below.

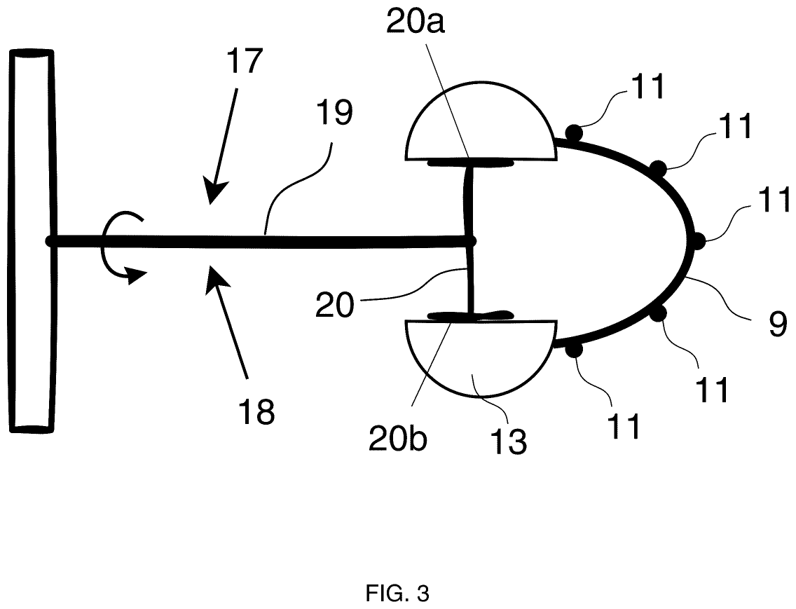

For capturing the acoustic representation 29 of the environment 1, the wearable acoustic device 9 may be placed on an object 17, preferably a rotatable stand 18 having a vertical axis of rotation 19. This can be seen in FIG. 3. The stand 18 may comprise a horizontal bar 20 attached to the axis of rotation 19 for holding the earpieces 13 of the wearable acoustic device 9 only so that the acoustic influences on the acoustic sensors 11 on the headband 12 are minimized. Plate-shaped holding elements 20a, 20b disposed at the ends of the horizontal bar 20 may be partially inserted into the earpieces 13 for fixation. The stand 18 allows to capture an acoustic representation 29 without influence of a wearer's head or body.

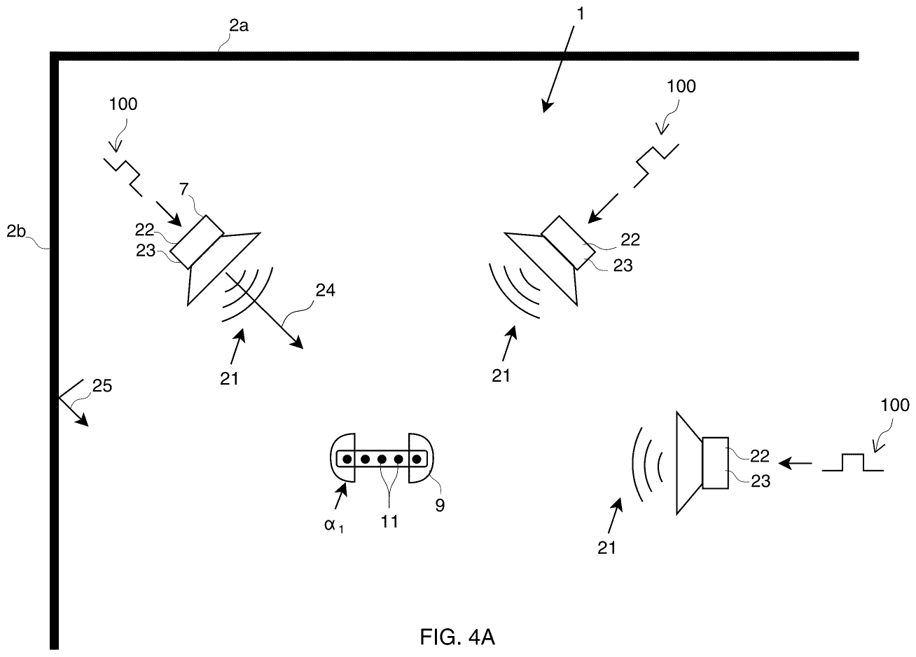

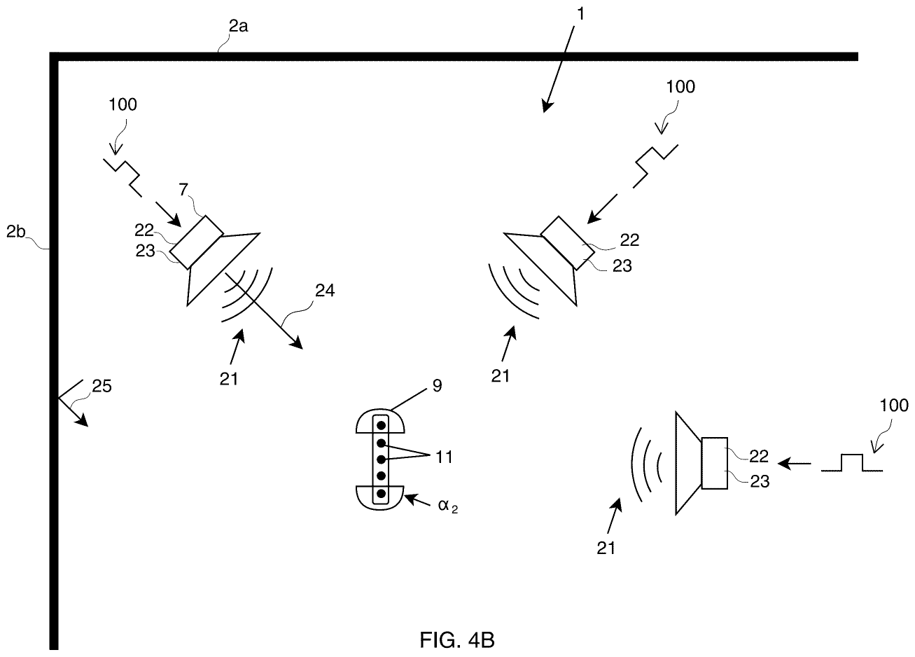

For capturing the acoustic representation 29, the wearable acoustic device 9 is at first placed in the environment 1 in a first orientation α1. This is shown in FIG. 4A.

After placing the wearable acoustic device 9 in the first orientation α1, people and other objects that shall not be part of the environment 1 are removed from the environment 1. Then, an acoustic signal 21 with a stimulus signal, for example an acoustic impulse 100 which approximates a Dirac Impulse, is emitted by at least one emitting unit 22, which may be a loudspeaker 23. In the embodiment shown, three loudspeakers 23 emit an acoustic signal 21 successively. Instead of an acoustic impulse 100, a Chirp signal or a Maximum Length Sequence (MLS) may be used. The acoustic sensors 11 may measure the acoustic signal 21 which directly arrives at the acoustic sensors 11, which may be referred to as direct sound 24, and reflections 25 from the walls 2a, 2b, the floor 3 and any other objects in the environment 1, such as the ceiling, pillars and furniture. This is schematically depicted in FIG. 1. Thereby, in the shown embodiment, the omnidirectional microphone 15a is used to capture the acoustic reaction of the environment 1, preferably the room impulse response 26, while all acoustic sensors 11 together may be used to capture directional information 27 (see FIG. 5B) corresponding to the acoustic reaction, namely of the directly arriving acoustic signal 21 (direct sound 24) and the reflections 25.

Then, the wearable acoustic device 9 is brought into a second orientation α2 by rotating it by 90° about the vertical axis 19 of the stand 18 (see FIG. 4B). In a next step, the acoustic signal 21 is again emitted by the emitting units 22. Again, the acoustic sensors 11 measure the acoustic signal 21 which directly arrives at the acoustic sensors 11 (direct sound 24) and reflections 25 from the walls 2a, 2b, the floor 3 and any other objects in the environment, such as the ceiling, pillars and furniture. Thereby, in the shown embodiment, the omnidirectional microphone 15a is used to capture the acoustic reaction of the environment 1, preferably the room impulse response 26, while all acoustic sensors 11 together may be used to capture directional information 27 corresponding to the acoustic reaction, namely of the directly arriving acoustic signal 21 (direct sound 24) and the reflections 25.

The wearable acoustic device can also be brought in further orientations different than the first α1 and second orientation α2. This may improve the estimation of the directional information 27 obtained from the microphone signals.

In order to determine directional information 27 an incoming sound signal, trigonometrical calculations based on phase differences and/or time differences of the incoming sound waves 16 may be performed. The trigonometrical calculations may yield directions of arrival of incoming sound waves 16 of direct sound 24 or reflections 25. Such calculations are, for example, explained in Knapp and G. Carter, “The Generalized Correlation Method for Estimation of Time Delay,” IEEE Trans. Acoust., Speech and Signal Proc., vol. 24, no. 4, pp. 320-327 (1976).

FIG. 5A schematically shows a captured acoustic reaction of the room in the form of a room impulse response 26. The abscissa represents the time t in milliseconds. The ordinate represents the sound pressure level p in Pascal, which is the deviation from the static pressure. The impulse response 26 comprises components 26a which may be attributed to the direct sound 24 and represent the direct arrival of the acoustic signal 21 at the wearable acoustic device 9. The impulse response 26 also comprises components 26b, 26c which may be attributed to the reflections 25 of the acoustic signal 21 at objects in the environment 1. The components 26b may be referred to as “early reflections” and represent the first reflections 25 reflected by the walls 2a, 2b and the floor 3 etc. arriving at the wearable acoustic device 9. The components 26c may be referred to as “late reverberation” and represent the late reflections 25 reflected by the walls 2a, 2b and the floor 3 etc. arriving at the wearable acoustic device 9. The “late reverberation” may also be referred to as “diffuse sound components”. The transition point between the “early reflections” and the “late reverberation” may be defined by the half 28 of the overall energy of the impulse response 26.

FIG. 5B schematically shows a composition of an acoustic representation 29 of the environment 1 as captured with the inventive method. The acoustic representation 29 comprises both the captured room impulse response 26 and the corresponding directional information 27. As shown in FIG. 5B, the room impulse response 26 may be split into two parts, namely a first part 30a comprising the components 26a, 26b—direct sound 24 and “early reflections”—and a second part 30b comprising the component 26c—“late reverberation” or “diffuse sound components”. The first part 30a comprises the components 26a, 26b before the half 28 of the overall energy of the impulse response 26. The second part 30b comprises the components 26c after the half 28 of the overall energy of the impulse response 26. The respective directional information 27 may be accorded to the first 30a and second part 30b.

The impulse response 26 may be a time discrete impulse response 26 with a sampling rate of, for example, 1 μs. To each sampling time tn, directional information 27, in particular a direction of arrival of the incoming sound waves 16, may be associated. This is shown in FIG. 5C. For example, to each sampling time tn, a spherical angle φ which describes the direction of arrival of the sound waves 16 may be associated. Instead of a spherical angle φ, also cartesian coordinates may be used, for instance.

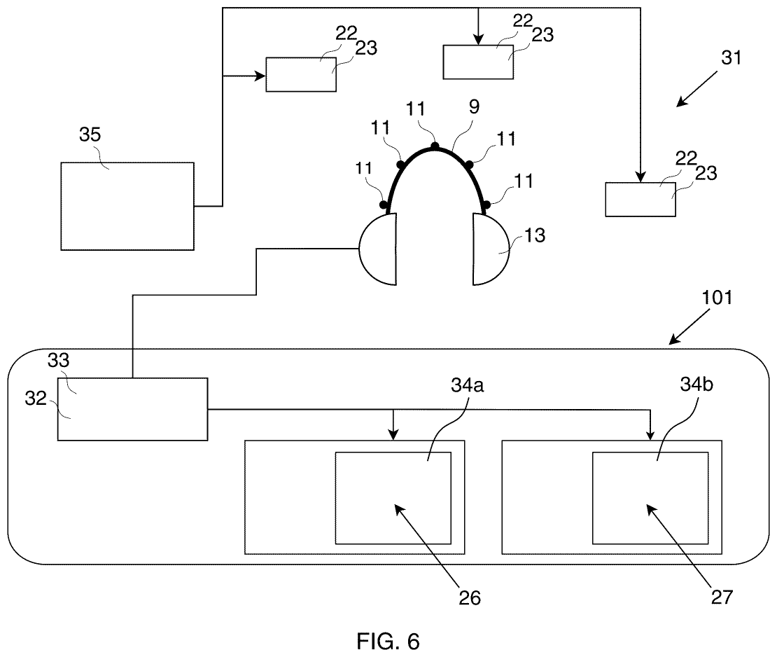

FIG. 6 schematically shows a system 31 for capturing an acoustic representation 29 of an environment 1 comprising a wearable acoustic device 9, three emitting units 22 in the form of loudspeakers 23 and a processing unit 32, which is configured to obtain the acoustic representation 29, i.e., the acoustic reaction of the acoustic reaction of the environment, preferably a room impulse response 26, and the corresponding directional information 27. As can be seen in FIG. 6, the processing unit 32 comprises a processor 33 for calculations. The memory section 34a is configured to store room impulse responses 26. The memory section 34b is configured to store corresponding directional information 27. The wearable acoustic device 9 may transmit measured acoustic signals 21 and reflections 25 to the processing unit 32 wirelessly, for example by means of Bluetooth, or Wifi, or over a connection cable. The emitting units 22 are connected to a playback device 35 which is configured to provide an acoustic signal 21 to the emitting units 22. In the shown embodiment, the processing unit 32 and the memory sections 34a, 34b may, for example, be part of a computational device 101, such as computer or a smartphone, from where the acoustic representation 29 may be uploaded to a server. In an alternative embodiment, the processing unit 32 for obtaining the acoustic representation 29 and the memory sections 34a, b may be included in a remote server, to which the unprocessed captured acoustic signals 21 and reflections may be sent for further processing. In another alternative embodiment, the processing unit 32 and preferably also the memory sections 34a, 34b may be included into the wearable acoustic device 9. In this embodiment of the invention, the wearable acoustic device 9 may perform a calculation of the acoustic representation 29. The memory sections 34a, 34b may store and provide several acoustic representations 29 of different environments 1.

After capturing and processing the acoustic representation 29, it may be stored in the memory sections 34a, 34b and provided to others with a similar wearable acoustic device 9 who would like to perceive music or voice as if it were played in the environment 1. The captured acoustic representation 29 stored in the memory sections 34a, 34b may thus be used to generate binaural sound signals 36r, 36l for a wearable acoustic device 9 which give a listener wearing the wearable acoustic device 9 the immersive impression as if they listening to music or voice in the environment 1. For example, the acoustic representation 29 may be uploaded to a server from where it can be downloaded.

The generation of the binaural sound signals 36r, 36l are schematically shown in FIG. 7. To generate binaural sound signals 36r, 36l, sound data 37, such as music or voice, may combined with the acoustic representation 29 by mathematic operations, such as convolution and matrix multiplication, as described in the following. During processing of the sound data 37, the combination of the acoustic representation 29 and the sound data 37 may be referred to as encoded signal 38 in FIG. 7.

To generate the binaural sound signals 36r, 36l, the input signal, in particular time discrete sound data 37, undergoes a processing chain of encoding and decoding with respect to the ambisonic format. The encoding part 102a includes applying a captured acoustic representation 29 on the input signal—the sound data 37—and the decoding part 102b incorporates an acoustic representation of a human 44, in particular head-related transfer functions or head-related impulse responses, as well as head movements of a listener to generate the binaural sound signals 36r, 36l.

In the following, an exemplary chain of encoding and decoding with respect to the ambisonic format will be described in detail.

The room impulse response 26, in the following also denoted as h(t) or h with an index in FIG. 7, is transformed into a directional impulse response hnm(t) by multiplying an encoder matrix Ynm(φ) with each time instant (denoted with tn) of the room impulse response 26, h(t) or h, respectively. The encoder matrix Ynm(φ) contains the directional information 27 and hence the respective spherical angle q of captured incident sound waves 16 corresponding to the room impulse response 26. For the sake of readability, the index nm of the encoder matrices Ynm are not shown in FIG. 7. Each index of φ of the encoder matrix Ynm(φ) in FIG. 7 corresponds to the index of the time instance tn of the room impulse response h(t). Also, the index of h(t) (simply denoted h in FIG. 7) corresponds to the time instance tn. hnm(t) may be calculated by the following formula:

$${h}_{n m} ( t ) = h ( t ) {Y}_{n m} ( φ ( t ) ) . \qquad ( equation l )$$

The encoder matrix Ynm may be, for example, a m×n matrix or a (n+1)2×1 vector. The dimension of the matrix or the vector depends on the spherical harmonics order m and degree n. Each coefficient of the matrix represents the general solution of the mathematical formulation of a spherical harmonic of the corresponding order and degree, which finally forms the encoder matrix and an orthonormal system. Details and examples regarding the encoder matrix Ynm, in particular regarding the order m and the degree n, may be found in the doctoral thesis Zotter, Franz. Analysis and synthesis of sound-radiation with spherical arrays. 2009. Also, the directional impulse response hnm(t) may be a n×L matrix, whereas L denotes the length of the impulse response h(t).

The sound data 37, hereinafter also denoted as s (t), is encoded into ambisonic signals χnm(t) by the convolution of the sound data 37 with the encoded directional room impulse response hnm(t):

$${χ}_{n m} ( t ) = {{h}_{n m} ( t )}^{*} s ( t ) . \qquad ( equation 2 )$$

χnm(t) is the encoded signal 38 in FIG. 7 and is a higher order ambisonic signal. Preferably, the order is 3.

One advantage of the acoustic representation 29 is that it comprises directional information 27 which may be used for adaptions of the binaural sound signals 36r, 36l according to movements of a listener's head who wears the wearable acoustic device 9. In this way, the listener may perceive changes in the binaural sound signals 36r, 36l as he or she moves his head with the wearable acoustic device 9. In order to measure the movement, in particular the orientation, of the wearable acoustic device 9, the wearable acoustic device 9 may comprise a tracking sensor 39, preferably an inertial measurement unit 40 (see FIG. 2). The tracking sensor 39 may measure the spherical angles Ψ of the wearable acoustic device 9.

By means of the measured orientations of the wearable acoustic device 9, the encoded signal 38 may be adapted accordingly. In the shown embodiment and as described below, this is done by a rotation matrix 41 to which the measured orientations of the wearable acoustic device 9 are fed into.

After adaption, i.e. rotation, of the encoded signal 38 to the measured orientation of the wearable acoustic device 9, the encoded signal 38 may be decoded by another mathematical operation 42 into right audio signals 43r and into left audio signals 431. The right 43r and the left audio signal 431 comprise direction dependent sub-signals and may be composed together into the binaural sound signals 36r, 36l, respectively.

As the acoustic representation 29 of the environment 1 does not comprise acoustic information of a listener's head, the right 43r and the left audio signals 431 may be combined with acoustic representations of a human 44, in particular acoustic representations of a human head 45. In this way, sound may be perceived more realistically. In the shown embodiment and as described below in greater detail, the right 43r and the left audio signals 431 are therefore combined with head-related transfer functions (HRTFs) 46 that represent the acoustical properties of a human head. As HRTFs change depending on the direction of incoming sound or orientation of a listener's head, respectively, the direction dependent sub-signals of the right 43r and left audio signals 431 may be combined with a set of direction-dependent HRTFs 46. Thereby, sub-signals of a certain direction are combined with corresponding HRTFs 46. In this way, a realistic and immersive sound perception can be created to the listener. After combination of the right 43r and left audio signals 431 with the HRTFs, the right audio signals 43r may be added up to the right binaural signal 36r and the left audio signals 431 may be added up to the left binaural signal 36l. These binaural signals 36r, 36 may be reproduced by the wearable acoustic device 9.

The decoding part 102b includes the direction dependent evaluation at the corresponding directions θ (with index i in FIG. 7) of the head-related impulse responses hHRIR(t)=(hL(t),hR(t)) for each ear of the listener 47 and by applying the pseudo inverse of the spherical harmonics coefficients Y−1 nm, which can be approximated in non-optimal case by Y†nm. The head-related impulse responses hL(t), hR(t) also depend on θ, as indicated in FIG. 7. The head rotation Ψ can be applied onto the encoded signal 38, which is an ambisonic signal, by using a rotation matrix Rnm(Ψ(t)) (R (Ψ(t) in FIG. 7). The encoded ambisonics signal χnm(t) may be multiplied with Rnm(Ψ(t)) at each time instance tn of χnm(t). An exemplary rotation matrix for ambisonics signals is described, for example, in Zotter, F., Frank, M. (2019). Signal Flow and Effects in Ambisonic Productions. In: Ambisonics. Springer Topics in Signal Processing, vol 19. Springer, Cham. https://doi.org/10.1007/978-3-030-17207-7_5. The binaural sound signals 36r, 36l may be calculated by using the following formulas:

$$y ( t ) = {\sum }_{n m} {{χ}_{r o {t}_{-} n m} ( t )}^{*} {h}_{H R I {R}_{-} n m} ( t ) , with \qquad ( equation 3 )$$

$${χ}_{{rot}_{-} n m ( t )} = {χ}_{n m} ( t ) {R}_{n m} ( Ψ ( t ) ) and \qquad ( equation 4 )$$

$${h}_{H R I {R}_{-} n m} ( t ) = {Y}_{n m}^{- 1} ( θ ) {h}_{H R I R} ( t ) . \qquad ( equation 5 )$$

The signal y(t) may then represent the left or right binaural sound signal 36r or 36l according to the HRIR set used. The signal processing for the two-part spatial impulse response differs only in the application of a rotation matrix, which is preferably omitted for the late part 26c (late reverberation) of the room impulse response 26.

Advantageously, only the encoded signal 38 may be adapted to the measured orientation of the wearable acoustic device 9. It is not necessary, to adapt the arrangement of the HRTFs 46 to the measured orientation of wearable acoustic device 9.

In order to further save computation time, only the first part 30a and the respective directional information 27 may be adapted to the measured orientations of the wearable acoustic device 9 as described above, while the second part 30b and the respective directional information 27 may be kept unprocessed in this aspect. This can be done without noticeable losses in quality as the “diffuse sound components” do only have minor influence to a listener's spatial perception.

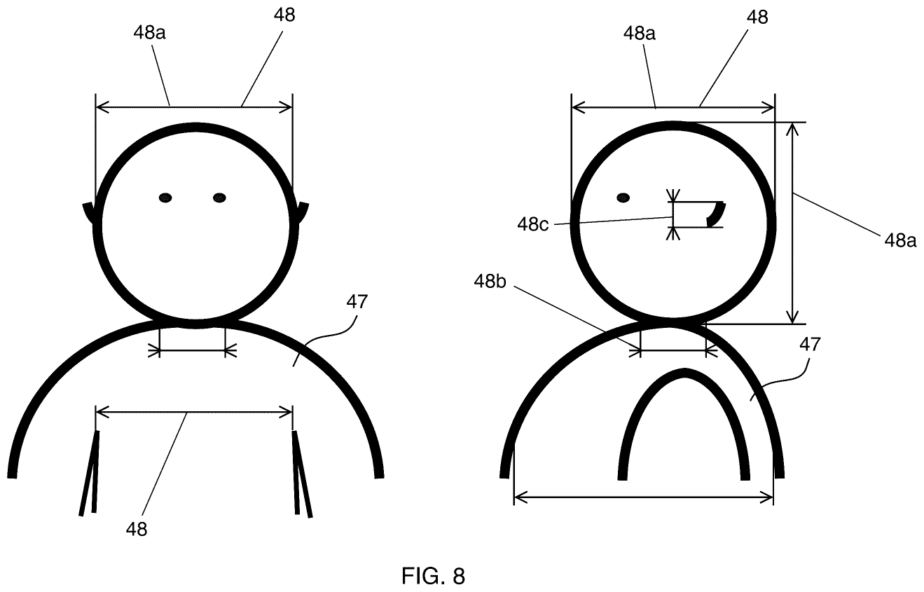

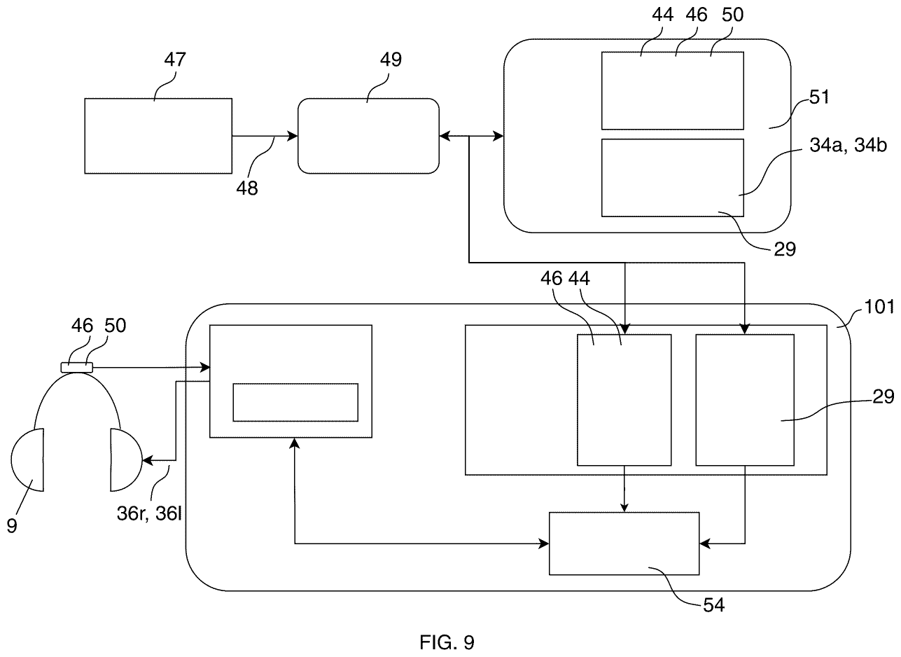

As each person has different anatomic properties (see FIG. 8), sound may be perceived differently. Thus, it is advantageously to find suitable representations of a human 44, in particular of a human head 45, that suit their anatomical properties. This may be done with the following selection procedure, wherein sets of HRTFs are used as representations of human heads 45 (see FIG. 9):

In a first step, a listener 47 may input his or her body dimensions 48 (see FIG. 9), such as the distance between the ears, circumference of the listener's head 48a, shoulder circumference 48b, ear size 48c, and/or height. The body dimensions 48 may be entered, for example, into the interface of an application 49, which may be installed on a smartphone, for example. Based on the listener's 47 input, a pool of multiple potentially suitable sets HRTFs 46 may be provided to the application 49. A large number of sets of HRTFs may be stored in and retrieved from a data base 50 of a server 51. The pool of potentially suitable sets of HRTFs may be downloaded and stored in a local device, such as a smartphone.

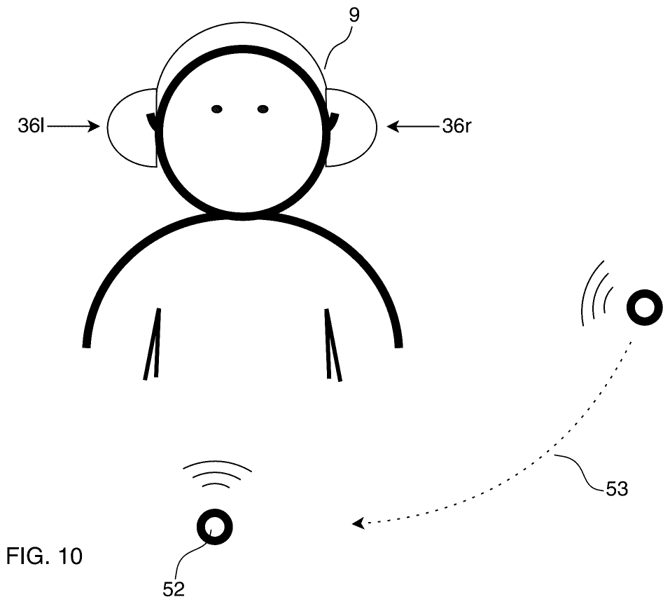

As shown in FIG. 10, the listener 47 may then wear the wearable acoustic device 9 and listen to binaural sound signals 36r, 36l reproduced by the wearable acoustic device 9 based on the potentially suitable sets of HRTFs one after another. The binaural sound signal 36r, 36l may give the impression of a virtual origin 52 and/or trajectory 53 from where the sound is coming from. The listener 47 may determine the virtual origin 52 and/or trajectory 53 by looking into the direction from where the binaural sound signals 36r, 36l seem to arrive from while wearing the wearable acoustic device 9. If the difference between the location and/or trajectory determined by the listener 47 and the actual virtual origin 52 and/or trajectory 53 of the binaural sound signal 36r, 36l is below a location threshold, the set of HRTFs based on which the binaural sound signal 36r, 36l have been generated may be considered suitable. The closer a determined location and/or trajectory is to the virtual origin 52 and/or trajectory 53, the more suitable a set of HRTFs is.

In a third step, the user may configurate the best matching sets of HRTFs, for example, by adapting the timbre.

After selecting the most suitable set of HRTFs, binaural sound signals 36r, 36l sound data 37 may be generated as described above by means of a processor 54 in a computational device 101, such as a smartphone or a computer (see FIG. 9). The computational device 101 may be the same as in FIG. 6. The computational device 101 is connected to the wearable acoustic device 9 via a cable or wirelessly. Thereby, the measured orientation of the tracking sensor 39 is sent to the computational device 101 and used to adapt the binaural sound signal 36r, 36l. Alternatively, the generation of binaural sound signals 36r, 36l, in particular the adaption of the binaural sound signals 36r, 36l to a listener's 47 head, may be carried out in the wearable acoustic device 9.

1. A method of capturing an acoustic representation of an environment, comprising the following steps:
i) placing a wearable acoustic device for acoustic reproduction into the environment, the wearable acoustic device being oriented in a first orientation and comprising at least three acoustic sensors configured to measure acoustic signals in the environment;
ii) emitting a first acoustic signal into the environment by means of at least one emitting unit, wherein, during the first acoustic signal, the wearable acoustic device is arranged in the first orientation;
iii) measuring the first acoustic signal and possible reflections in the environment by means of the at least three acoustic sensors;
iv) arranging the wearable acoustic device from the first orientation into a second orientation, which is different from the first orientation;
v) after emitting the first acoustic signal, emitting a second acoustic signal into the environment by means of the at least one emitting unit, wherein, during the second acoustic signal, the wearable acoustic device is arranged in the second orientation;
vi) measuring the second acoustic signal and possible reflections in the environment by means of the at least three acoustic sensors; and
vii) obtaining the acoustic representation of the environment based on the first and the second measured acoustic signal and the measured possible reflections, the acoustic representation including a room impulse response in response to the first and the second acoustic signal emitted by the emitting unit and a directional information corresponding to the room impulse response,
wherein the at least three acoustic sensors form a curved line array, and
wherein one of the at least three acoustic sensors, which is an omnidirectional acoustic sensor, is used for obtaining the room impulse response and at least two of the at least three acoustic sensors are used for obtaining the directional information corresponding to the room impulse response.

2. The method according to claim 1, wherein the acoustic representation of the environment is a directional room impulse response composed of the room impulse response and corresponding directional information.

3. (canceled)

4. The method according to claim 1, wherein the wearable acoustic device is placed on an object.

5. The method according to any of claim 1, wherein the first acoustic signal and/or the second acoustic signal comprises a stimulus signal.

6. The method according to claim 1, wherein the at least three acoustic sensors are located in or on a headband of the wearable acoustic device.

7. The method according to claim 1, wherein all of the at least three acoustic sensors, are used for obtaining directional information corresponding to the room impulse response.

8. (canceled)

9. A method of generating a binaural sound signal (36r, 36l), the binaural sound signal emulating reproduction in an environment, comprising the following steps:
capturing an acoustic representation of the environment by applying the method of capturing the acoustic representation of the environment according to claim 1; and
generating the binaural sound signal by combining the captured acoustic representation of the environment with an acoustic representation of a human and with sound data.

10. The method according to claim 9, wherein the binaural sound signal is reproduced in the wearable acoustic device.

11. The method according to claim 10, wherein the wearable acoustic device comprises a tracking sensor which tracks a movement of the wearable acoustic device, wherein the binaural sound signal is adapted to the tracked movement based on the directional information included in the acoustic representation.

12. The method according to claim 9, wherein the acoustic representation of a human is selected from a data base comprising multiple representations of a human.

13-15. (canceled)

16. The method according to claim 1, wherein the wearable acoustic device for acoustic reproduction comprises headphones.

17. The method according to claim 1, wherein the emitting unit comprises a loudspeaker.

18. The method according to claim 1, wherein the environment comprises a room with a specific audio playback situation.

19. The method according to claim 4, wherein the object is a stand for the wearable acoustic device with a defined axis of rotation.

20. The method according to claim 5, wherein the stimulus signal is a chirp signal or an impulse.

21. The method according to claim 5, wherein the stimulus signal is a trigger signal.

22. The method according to claim 9, wherein the acoustic representation of a human is an acoustic representation of a human head.

23. The method according to claim 22, wherein the acoustic representation of a human head is a head-related transfer function or a head-related impulse response.

24. The method according to claim 9, wherein the sound data is music or voice.

25. The method according to claim 10, wherein the wearable acoustic device comprises headphones.
